(19) United States
(12) Patent Application Publication
(10) Pub. No.: US 2017/0203748 A1
(43) Pub. Date: Jul. 20, 2017

(54) CONTROL DEVICE FOR HYBRID WORK MACHINE, HYBRID WORK MACHINE, AND CONTROL METHOD FOR HYBRID WORK MACHINE

(71) Applicant: KOMATSU LTD., Tokyo (JP)

(72) Inventors: Tomotaka Imai, Hiratsuka-shi (JP); Masaru Shizume, Yokohama-shi (JP)

(21) Appl. No.: 15/112,240

(22) PCT Filed: Jan. 20, 2016
(86) PCT No.: PCT/JP2016/051624

§ 371 Date: Jul. 18, 2016

(51) Int. Cl. B60W 20/10; B60W 10/08; F01N 3/10; F02D 29/06; F01N 3/20; B60W 10/06; F02B 63/04

(52) U.S. Cl. CPC B60W 20/10; B60W 10/06; B60W 10/08; F02B 63/04; F02D 29/06; F01N 3/2066; F01N 3/103; B60W 2510/0666; B60W 2710/086; Y10S 903/906

(57) ABSTRACT

A control method for a hybrid work machine that includes an internal combustion engine that drives a working unit, and a generator motor connected to the internal combustion engine and transfers and receives electric power to/from a power storage device, the control method includes: determining whether a situation is at a time of an output limitation in which an output of the internal combustion engine is limited; at the time of the output limitation, limiting an assist operation of supplying the electric power stored in the power storage device to the generator motor in a case of increasing an output of the internal combustion engine based on a work request for the working unit at a time of working; and controlling the internal combustion engine and the generator motor in a state in which the assist operation is limited.

### FIELD

The present invention relates to a control device for a hybrid work machine, a hybrid work machine, and a control method for a hybrid work machine.

### BACKGROUND

A work machine includes, for example, an internal combustion engine as a power source that generates motive power for traveling or motive power for operating a working unit. Recently, for example, as described in Patent Literature 1, there is a hybrid work machine that, by combining an internal combustion engine and a generator motor, generates electric power by driving the generator motor by the internal combustion engine while using motive power generated by the internal combustion engine as motive power for the work machine. The hybrid work machine includes a power storage device that stores, for example, electric power generated by the generator motor. The hybrid work machine described above can drive the generator motor by supplying the electric power stored in the power storage device to the generator motor based on a work request for the working unit, such as an assist operation for increasing a rotational speed of the internal combustion engine.

### CITATION LIST

### Patent Literature

Patent Literature 1: Japanese Patent Application Laid-open No. 2012-241585

### SUMMARY

### Technical Problem

In the above-mentioned hybrid work machine, in a condition such as a case that an operation is continued in a state where untreated exhaust gas is discharged from an internal combustion engine or the like, a control to limit an output of the internal combustion engine is performed. In a case where an output of an internal combustion engine is limited, because it becomes difficult to secure an output to store power in a power storage device, there is a possibility that a storage capacity of the power storage device is reduced and a power generation output is insufficient.

An aspect of the present invention has an object to provide a control device for a hybrid work machine, a hybrid work machine, and a control method for a hybrid work machine that can suppress a power generation output insufficiency of a power storage device in a case where an output of an internal combustion engine is limited.

### Solution to Problem

According to a first aspect of the present invention, a control device that controls a hybrid work machine, wherein the hybrid work machine includes: a working unit; an internal combustion engine that supplies motive power to the working unit; a generator motor connected to an output shaft of the internal combustion engine; and a power storage device that stores electric power generated by the generator motor, or supplies electric power to the generator motor, the control device comprising: a determination unit that determines whether a situation is at a time of an output limitation in which an output of the internal combustion engine is limited; an assist control unit that limits, at the time of the output limitation, an assist operation of supplying the electric power stored in the power storage device to the generator motor in a case of increasing an output of the internal combustion engine based on a work request for the working unit at a time of working; and an engine control unit that controls the internal combustion engine and the generator motor in a state in which the assist operation is limited by the assist control unit.

According to a second aspect of the present invention, in the control device that controls the hybrid work machine according to the first aspect, the assist control unit stops the assist operation at the time of the output limitation.

According to a third aspect of the present invention, in the control device that controls the hybrid work machine according to the first aspect or the second aspect, the determination unit determines that a situation is at the time of the output limitation in a case where the internal combustion engine and peripheral equipment of the internal combustion engine are in abnormal states, and/or in a case where a purifying ability of an exhaust gas treating device, when the exhaust gas treating device is provided in the internal combustion engine, is reduced or possibly reduced.

According to a fourth aspect of the present invention, in the control device that controls the hybrid work machine according to the third aspect, the peripheral equipment includes: the exhaust gas treating device that treats exhaust gas of the internal combustion engine; an injection device that injects fuel into the internal combustion engine; and a cooling device that cools the internal combustion engine.

According to a fifth aspect of the present invention, in the control device that controls the hybrid work machine according to any one of the first aspect to the fourth aspect, at the time of the output limitation, the engine control unit changes to a matching rotational speed in an output limited mode through a control of increasing a rotational speed of the internal combustion engine based on the work request for the working unit at the time of working.

According to a sixth aspect of the present invention, a hybrid work machine comprises: an internal combustion engine that includes an exhaust gas treating device; a generator motor coupled to an output shaft of the internal combustion engine; a power storage device that stores electric power generated by the generator motor, or supplies electric power to the generator motor; and the control device that controls the hybrid work machine according to any one of the first aspect to the fourth aspect, the control device controlling the internal combustion engine, the generator motor, and the power storage device.

According to a seventh aspect of the present invention, the control device that controls the hybrid work machine according to the sixth aspect, further comprises: a vehicle body that includes a traveling body, and a swing body provided on the traveling body and swingable relative to the traveling body; and a motor provided such that electric power is supplied from the generator motor and/or the power storage device, the motor driving the swing body.

According to an eighth aspect of the present invention, a control method for a hybrid work machine that includes an internal combustion engine that drives a working unit, and a generator motor connected to the internal combustion engine and transfers and receives electric power to/from a power storage device, the control method comprises: determining whether a situation is at a time of an output limitation in which an output of the internal combustion engine is limited; at the time of the output limitation, limiting an assist operation of supplying the electric power stored in the power storage device to the generator motor in a case of increasing an output of the internal combustion engine based on a work request for the working unit at a time of working; and controlling the internal combustion engine and the generator motor in a state in which the assist operation is limited.

According to the aspect of the present invention, the power generation output insufficiency of the power storage device, in a case where the output of the internal combustion engine is limited, can be suppressed.

### BRIEF DESCRIPTION OF DRAWINGS

FIG. 1 is a perspective view illustrating an excavator which is a work machine according to an embodiment.

FIG. 2 is a schematic diagram illustrating a drive system of the excavator according to the embodiment.

FIG. 3 is a schematic diagram illustrating an exhaust gas treating device according to the embodiment.

FIG. 4 is a diagram illustrating an example of a torque diagram used for the control of an engine according to the embodiment.

FIG. 5 is a diagram illustrating an exemplary configuration of a hybrid controller.

FIG. 6 is a table illustrating the relationship between the remaining amount of a reducing agent and an output limited mode of an internal combustion engine.

FIG. 7 is a diagram illustrating an example of a control block of a determination unit.

FIG. 8 is a diagram illustrating an example of a control block of an engine control unit.

FIG. 9 is a diagram illustrating an example of the control block of the engine control unit.

FIG. 10 is a diagram illustrating an example of a control block of an assist control unit.

FIG. 11 is a flowchart illustrating an example of a control method for a hybrid work machine according to the embodiment.

FIG. 12 is a diagram illustrating a comparative example of a torque diagram in the output limited mode.

FIG. 13 is a diagram illustrating an example of the torque diagram in the output limited mode.

FIG. 14 is a diagram illustrating an example of the torque diagram in the output limited mode.

### DESCRIPTION OF EMBODIMENTS

A mode to implement (embodiment of) the present invention will be described in detail with reference to the drawings.

<Overall Configuration of Work Machine>

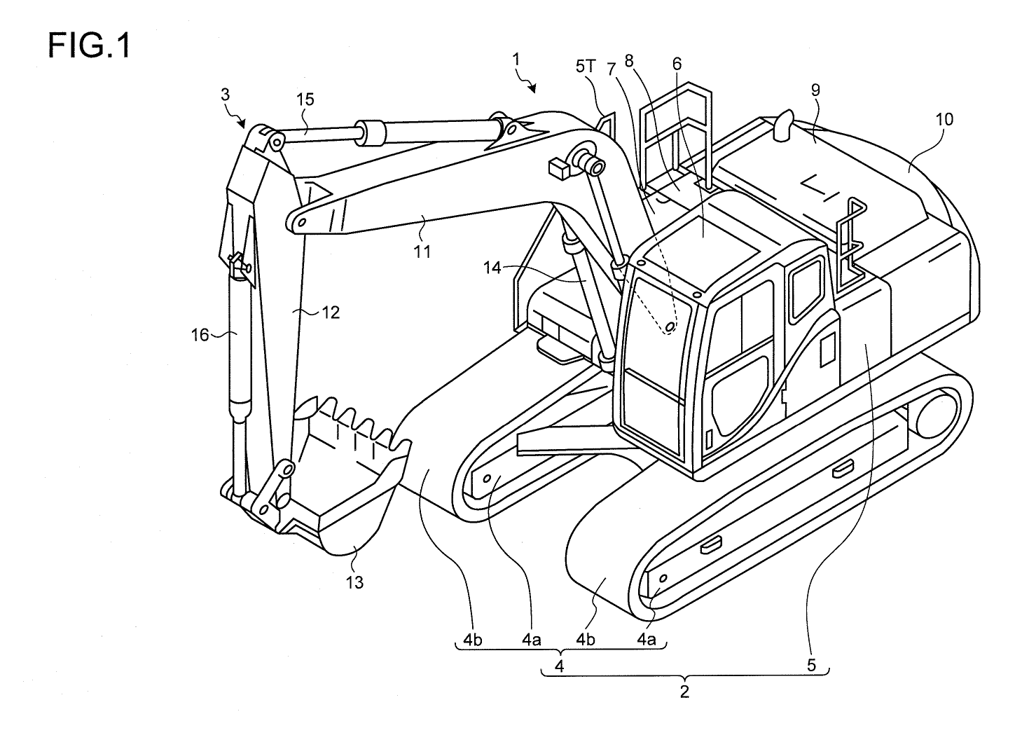

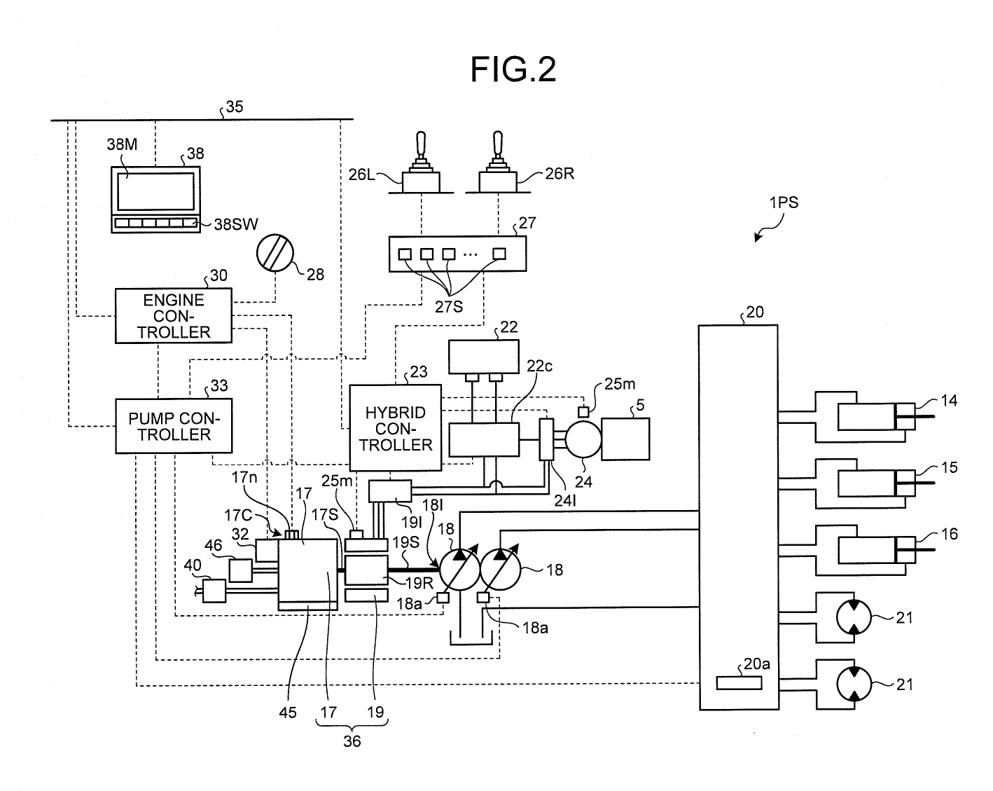

FIG. 1 is a perspective view illustrating an excavator 1 as a work machine according to an embodiment. The excavator 1 includes a vehicle body 2 and a working unit 3. The vehicle body 2 includes a lower traveling body 4 and an upper swing body 5. The lower traveling body 4 includes a pair of traveling devices 4a, 4a. The traveling devices 4a, 4a include tracks 4b, 4b, respectively. Each of the traveling devices 4a, 4a includes traveling motors 21. The traveling motors 21 illustrated in FIG. 2 drive the track 4b on the left side. The excavator 1, although not illustrated in FIG. 1, includes traveling motors that drive the track 4b on the right side. The traveling motors that drive the track 4b on the left side are referred to as left traveling motors, and the traveling motors that drive the track 4b on the right side are referred to as right traveling motors. The right traveling motors and the left traveling motors cause the excavator 1 to travel or swing by driving the tracks 4b, 4b, respectively.

The upper swing body 5 which is an example of a swing body is swingably provided on the lower traveling body 4. The excavator 1 is swung by a swing motor for swinging the upper swing body 5. The swing motor may be an electric motor that converts electric power into rotational power, a hydraulic motor that converts the pressure of working oil (hydraulic pressure) into rotational power, or a combination of the hydraulic motor and the electric motor. The swing motor is the electric motor in the embodiment.

The upper swing body 5 includes an operator room 6. In addition, the upper swing body 5 includes a fuel tank 7, a working oil tank 8, an engine room 9, and a counterweight 10. The fuel tank 7 stores fuel for driving an engine. The working oil tank 8 stores working oil discharged from a hydraulic pump to hydraulic cylinders such as a boom cylinder 14, an arm cylinder 15, and a bucket cylinder 16, and hydraulic equipment such as the traveling motors 21. The engine room 9 houses an engine that serves as a power source for the excavator, and equipment such as the hydraulic pump that supplies the working oil to the hydraulic equipment. The counterweight 10 is arranged behind the engine room 9. A handrail 5T is provided above the upper swing body 5.

The working unit 3 is attached to a middle position of a front portion of the upper swing body 5. The working unit 3 includes a boom 11, an arm 12, a bucket 13, the boom cylinder 14, the arm cylinder 15, and the bucket cylinder 16. A base end portion of the boom 11 is coupled to the upper swing body 5 with a pin. With the structure described above, accordingly, the boom 11 operates with respect to the upper swing body 5.

The boom 11 is coupled to the arm 12 with a pin. More specifically, a tip end portion of the boom 11 is coupled to a base end portion of the arm 12 with a pin. A tip end portion of the arm 12 is coupled to the bucket 13 with a pin. With the structure described above, accordingly, the arm 12 operates with respect to the boom 11. In addition, the bucket 13 operates with respect to the arm 12.

The boom cylinder 14, the arm cylinder 15, and the bucket cylinder 16 are the hydraulic cylinders driven by the working oil discharged from the hydraulic pump. The boom cylinder 14 operates the boom 11. The arm cylinder 15 operates the arm 12. The bucket cylinder 16 operates the bucket 13.

<Drive System 1PS of Excavator 1>

FIG. 2 is a schematic diagram illustrating a drive system of the excavator 1 according to the embodiment. In the embodiment, the excavator 1 is a hybrid work machine in which an internal combustion engine 17, a generator motor 19, a power storage device 22, and a motor are combined. The generator motor 19 is driven by the internal combustion engine 17 and thus, generates electric power. The power storage device 22 stores the electric power. The motor is driven by the electric power generated by the generator motor 19 supplied thereto, or the electric power discharged from the power storage device 22 supplied thereto. More specifically, the excavator 1 swings the upper swing body 5 by a motor 24 (hereinafter, appropriately referred to as a swing motor 24).

The excavator 1 includes the internal combustion engine 17, a hydraulic pump 18, the generator motor 19, and the swing motor 24. The internal combustion engine 17 is a power source for the excavator 1. In the embodiment, the internal combustion engine 17 is a diesel engine. The generator motor 19 is coupled to an output shaft 17S of the internal combustion engine 17. With the structure described above, accordingly, the generator motor 19 is driven by the internal combustion engine 17 and thus, generates the electric power. In addition, when motive power generated by the internal combustion engine 17 is insufficient, the generator motor 19 is driven by the electric power supplied from the power storage device 22 and assists the internal combustion engine 17.

In the embodiment, the internal combustion engine 17 is a diesel engine; however, the engine is not limited to this. The generator motor 19 is, for example, a switched reluctance (SR) motor; however, the motor is not limited to this. In the embodiment, the generator motor 19 has a structure in which a rotor 19R is coupled directly to the output shaft 17S of the internal combustion engine 17; however, the structure is not limited to this. For example, in the generator motor 19, the rotor 19R and the output shaft 17S of the internal combustion engine 17 may be connected via a power take off (PTO). The rotor 19R of the generator motor 19 may be coupled to a transmission means such as a speed reducer connected to the output shaft 17S of the internal combustion engine 17, and may be driven by the internal combustion engine 17. In the embodiment, a combination of the internal combustion engine 17 and the generator motor 19 serves as a power source for the excavator 1. The combination of the internal combustion engine 17 and the generator motor 19 is appropriately referred to as an engine 36. The engine 36 is a hybrid engine in which the internal combustion engine 17 and the generator motor 19 are combined, and which generates motive power required for the excavator 1 which is a work machine.

The internal combustion engine 17 includes, as peripheral equipment, an exhaust gas treating device 40, an injection device 45, and a cooling device 46. The exhaust gas treating device 40 treats exhaust gas or the like. The injection device 45 injects fuel. The cooling device 46 circulates cooling water that cools the internal combustion engine 17. The exhaust gas treating device 40 will be described later.

The injection device 45 is a so-called common-rail type device that, for example, includes a pressure-storing chamber and an injector. The injection device 45 is controlled by an engine controller 30. Specifically, the engine controller 30 injects, from the injector, an appropriate amount of fuel in accordance with operational conditions such as a rotational speed and load of the internal combustion engine 17. In the present embodiment, the injection device 45 is not limited to the common-rail type. The cooling device 46 includes a drive source (not illustrated) such as a pump that drives the cooling water. The cooling device 46 includes a temperature sensor (not illustrated) that detects the temperature of the cooling water and outputs the detected temperature to the engine controller 30.

The hydraulic pump 18 supplies the working oil to the hydraulic equipment. In the present embodiment, a variable displacement hydraulic pump such as a swash plate type hydraulic pump is used as the hydraulic pump 18. An input unit 181 of the hydraulic pump 18 is coupled to a power transmission shaft 19S coupled to the rotor of the generator motor 19. With the structure described above, accordingly, the hydraulic pump 18 is driven by the internal combustion engine 17.

The drive system 1PS includes the power storage device 22 and a swing motor control device 241 as electric drive systems for driving the swing motor 24. In the embodiment, the power storage device 22 is a capacitor, and more specifically, an electric double-layered capacitor; however, the power storage device is not limited to this. For example, the power storage device 22 may be a secondary battery such as a nickel hydride battery, a lithium ion battery, and a lead storage battery. The swing motor control device 241 is, for example, an inverter. A target voltage value of the electric power stored in the power storage device 22 is controlled to be a constant value when the excavator 1 is working, for example.

The electric power generated by the generator motor 19 or the electric power discharged from the power storage device 22 is supplied to the swing motor 24 via a power cable, and swings the upper swing body 5 illustrated in FIG. 1. In other words, the swing motor 24 swings the upper swing body 5 by power-running operation using the electric power supplied from (generated by) the generator motor 19 or the electric power supplied (discharged) from the power storage device 22. The swing motor 24 supplies (charges) the electric power to the power storage device 22 by performing regenerative operation when the speed of the upper swing body 5 is reduced. The generator motor 19 supplies (charges) the electric power generated by itself to the power storage device 22. That is, the power storage device 22 can also store the electric power generated by the generator motor 19.

The generator motor 19 is driven by the internal combustion engine 17 and thus, generates electric power. In addition, the generator motor 19 is driven by the electric power supplied from the power storage device 22 and drives the internal combustion engine 17 thereby. A hybrid controller 23 controls the generator motor 19 via a generator motor control device 19I. In other words, the hybrid controller 23 generates a control signal for driving the generator motor 19 and provides the control signal to the generator motor control device 19I. The generator motor control device 19I, based on the control signal, generates electric power in the generator motor 19 (regeneration) and motive power in the generator motor 19 (power-running). The generator motor control device 19I is, for example, an inverter.

A rotation sensor 25m is provided in the generator motor 19. The rotation sensor 25m detects a rotational speed of the generator motor 19, i.e., a rotational frequency per unit time of the rotor 19R. The rotation sensor 25m converts the detected rotational speed into an electric signal and outputs the electric signal to the hybrid controller 23. The hybrid controller 23 acquires the rotational speed of the generator motor 19 detected by the rotation sensor 25m, and uses such rotational speed for controlling operating states of the generator motor 19 and the internal combustion engine 17. For example, a resolver or a rotary encoder is used as the rotation sensor 25m. In the embodiment, the PTO or the like is interposed between the generator motor 19 and the internal combustion engine 17. Therefore, the rotational speed of the generator motor 19 and the rotational speed of the internal combustion engine 17 have a certain ratio in accordance with a gear ratio of the PTO or the like. In the embodiment, the rotation sensor 25m may detect the rotational frequency of the rotor 19R of the generator motor 19. In addition, the hybrid controller 23 may convert the rotational frequency into a rotational speed. In the embodiment, the rotational speed of the generator motor 19 can be replaced by a value detected by a rotational speed detection sensor 17n of the internal combustion engine 17. The generator motor 19 and the internal combustion engine 17 may be coupled directly without involving the PTO or the like.

The rotation sensor 25m is provided in the swing motor 24. The rotation sensor 25m detects a rotational speed of the swing motor 24. The rotation sensor 25m converts the detected rotational speed into an electric signal and outputs the electric signal to the hybrid controller 23. For example, an embedded magnet synchronous motor is used as the swing motor 24. For example, a resolver or a rotary encoder is used as the rotation sensor 25m.

The hybrid controller 23 acquires signals of detection values from the temperature sensors such as thermistors or thermocouples provided in the generator motor 19, the swing motor 24, the power storage device 22, a booster 22c, the swing motor control device 241, and the generator motor control device 19I described later. Based on the acquired temperature, the hybrid controller 23 controls, while managing the temperature of each of the equipment such as the power storage device 22, the charging/discharging of the electric power in the power storage device 22, the power generation by the generator motor 19, the assist of the internal combustion engine 17, and the power-running and the regeneration of the swing motor 24. In addition, the hybrid controller 23 executes a control method according to the embodiment.

The drive system 1PS includes operation levers 26R, 26L. The operation levers 26R, 26L are provided at positions corresponding to the left and right sides of the operator-seated position in the operator room 6 provided in the vehicle body 2 illustrated in FIG. 1. The operation levers 26R, 26L are devices that operate the working unit 3 and operate the traveling of the excavator 1. The operation levers 26R, 26L operate the working unit 3 and the upper swing body 5 in accordance with the respective operations.

A pilot hydraulic pressure is generated based on the operation amount of the operation levers 26R, 26L. The pilot hydraulic pressure is supplied to a control valve described later. The control valve adjusts the flow rate of the working oil supplied to the working unit 3 depending on the pilot hydraulic pressure, and supplies the working oil to the boom cylinder 14, the arm cylinder 15, and the bucket cylinder 16. Accordingly, for example, the lowering/raising operation of the boom 11 is performed in response to the operation of the operation lever 26R in the front-rear direction, and the excavating/dumping of the bucket 13 is performed in response to the operation of the operation lever 26R in the left-right direction. Furthermore, for example, the dumping/excavating operation of the arm 12 is performed by the operation of the operation lever 26L in the front-rear direction. The operation amounts of the operation levers 26R, 26L are converted into electric signals by a lever operation amount detection unit 27. The lever operation amount detection unit 27 is provided with pressure sensors 27S. The pressure sensors 27S detect the pilot hydraulic pressure generated by the operation of the operation levers 26L, 26R. The pressure sensors 27S output the voltage corresponding to the detected pilot hydraulic pressure. The lever operation amount detection unit 27 determines the lever operation amount by converting the voltage output from the pressure sensors 27S into the operation amount.

The lever operation amount detection unit 27 outputs the lever operation amount as the electric signal to a pump controller 33 and/or the hybrid controller 23. In a case where the operation levers 26L, 26R are electrical levers, the lever operation amount detection unit 27 is provided with an electrical detection device such as a potentiometer. The lever operation amount detection unit 27 determines the lever operation amount by, in accordance with the lever operation amount, converting the voltage generated by the electrical detection device into the lever operation amount. Accordingly, for example, the swing motor 24 is driven in the left-right swinging direction by the left-right operation of the operation lever 26L, respectively. In addition, the traveling motor 21 is driven by left and right traveling levers (not illustrated).

A fuel adjustment dial 28 is provided inside the operator room 6 illustrated in FIG. 1. Hereinafter, the fuel adjustment dial 28 is appropriately referred to as a throttle dial 28. The throttle dial 28 sets the amount of fuel supplied to the internal combustion engine 17. A set value (also referred to as a command value) of the throttle dial 28 is converted into an electric signal, and is output to a control device 30 of the internal combustion engine (hereinafter, appropriately referred to as an engine controller 30). A rotational frequency of the internal combustion engine 17 is set by the throttle dial 28.

The engine controller 30 acquires output values such as the rotational speed and water temperature of the internal combustion engine 17 from sensors 17C that detect the state of the internal combustion engine 17. Then, the engine controller 30 determines the state of the internal combustion engine 17 based on the acquired output values from the sensors 17C, and controls the output of the internal combustion engine 17 by adjusting the injection amount of the fuel with respect to the internal combustion engine 17. In the embodiment, the engine controller 30 includes a computer that has a processor such as a CPU, and a memory.

The engine controller 30 generates a signal of a control command for controlling the operation of the internal combustion engine 17 based on the set value of the throttle dial 28. The engine controller 30 transmits the generated control signal to a common rail control unit 32. The common rail control unit 32 that has received the control signal adjusts the fuel injection amount with respect to the internal combustion engine 17. That is, in the embodiment, the internal combustion engine 17 is a diesel engine capable of common-rail type electronic control. The engine controller 30 can cause the internal combustion engine 17 to generate the target output by controlling the amount of the fuel injected into the internal combustion engine 17 via the common rail control unit 32. The engine controller 30 can also freely set a torque that can be output at a rotational speed of the internal combustion engine 17 at a given moment. The hybrid controller 23 and the pump controller 33 receive the set value of the throttle dial 28 from the engine controller 30.

The internal combustion engine 17 is provided with the rotational speed detection sensor 17n. The rotational speed detection sensor 17n detects a rotational speed of the output shaft 17S of the internal combustion engine 17, i.e., a rotational frequency per unit time of the output shaft 17S. The engine controller 30 and the pump controller 33 acquire the rotational speed of the internal combustion engine 17 detected by the rotational speed detection sensor 17n, and use such rotational speed for controlling the operating state of the internal combustion engine 17. In the embodiment, the rotational speed detection sensor 17n may detect the rotational frequency of the internal combustion engine 17. In addition, the engine controller 30 and the pump controller 33 may convert the rotational frequency into a rotational speed. In the embodiment, the actual rotational speed of the internal combustion engine 17 can be replaced by a value detected by the rotation sensor 25m of the generator motor 19.

The pump controller 33 controls the flow rate of the working oil discharged from the hydraulic pump 18. In the embodiment, the pump controller 33 includes a computer that has a processor such as a CPU, and a memory. The pump controller 33 receives the signals transmitted from the engine controller 30 and the lever operation amount detection unit 27. Then, the pump controller 33 generates a signal of a control command for adjusting the flow rate of the working oil discharged from the hydraulic pump 18. The pump controller 33 changes the flow rate of the working oil discharged from the hydraulic pump 18 by changing a swash plate angle of the hydraulic pump 18 using the generated control signal.

A signal from a swash plate angle sensor 18a that detects the swash plate angle of the hydraulic pump 18 is input to the pump controller 33. The swash plate angle sensor 18a detects the swash plate angle and thus, the pump controller 33 can calculate a pump capacity of the hydraulic pump 18. A pump pressure detection unit 20a for detecting a discharging pressure (hereinafter, appropriately referred to as a pump discharging pressure) of the hydraulic pump 18 is provided inside a control valve 20. The detected pump discharging pressure is converted into an electric signal, and is input to the pump controller 33.

The engine controller 30, the pump controller 33, and hybrid controller 23 are connected via an in-vehicle local area network (LAN) 35 such as a controller area network (CAN). With the structure described above, accordingly, the engine controller 30, the pump controller 33, and the hybrid controller 23 can exchange information with one another.

In the embodiment, at least the engine controller 30 controls the operating state of the internal combustion engine 17. In such case, the engine controller 30 controls the operating state of the internal combustion engine 17 using the information generated by the pump controller 33 and/or the hybrid controller 23. As described above, in the embodiment, at least one of the engine controller 30, the pump controller 33, and the hybrid controller 23 functions as the control device for a hybrid work machine. In other words, at least one of the engine controller 30, the pump controller 33, and the hybrid controller 23 implements a control method for a hybrid work machine according to the embodiment, and controls the operating state of the engine 36. Hereinafter, in a case where the engine controller 30, the pump controller 33, and the hybrid controller 23 are not distinguished from one another, such controllers are referred to as the control devices for a hybrid work machine. In the embodiment, the engine controller 30 implements a function of the control device for a hybrid work machine.

A monitor 38 includes a display unit 38M and an operation unit 38SW. The display unit 38M displays information regarding the state of the excavator 1 such as the rotational speed of the internal combustion engine 17, the cooling-water temperature of the internal combustion engine 17, the pressure of the working oil discharged from the hydraulic pump 18, and a power storage capacity of the power storage device 22. The operation unit 38SW is a mechanism for changing over an operation mode of the excavator 1, and for displaying and selecting various menus.

A fuel saving mode in which the rotational frequency of the internal combustion engine 17 is put into an idling state is an example of the operation mode of the excavator 1. An auto-deceleration function is set in the excavator 1 of the present embodiment. The auto-deceleration function is to improve the fuel economy by shifting to a rotational deceleration mode when a predetermined condition has been established in a working state. The setting of the auto-deceleration function can be appropriately cancelled by the operator of the excavator 1. The operation mode of the excavator 1 is not limited to the example in the embodiment, and various operating modes are present other than the example. Other than the operation unit 38SW of the monitor 38, the operation mode of the excavator 1 may be changed over by, for example, an operation mode changeover switch provided inside the operator room 6 of the excavator 1 illustrated in FIG. 1.

<Internal Combustion Engine 17 and Exhaust Gas Treating Device 40>

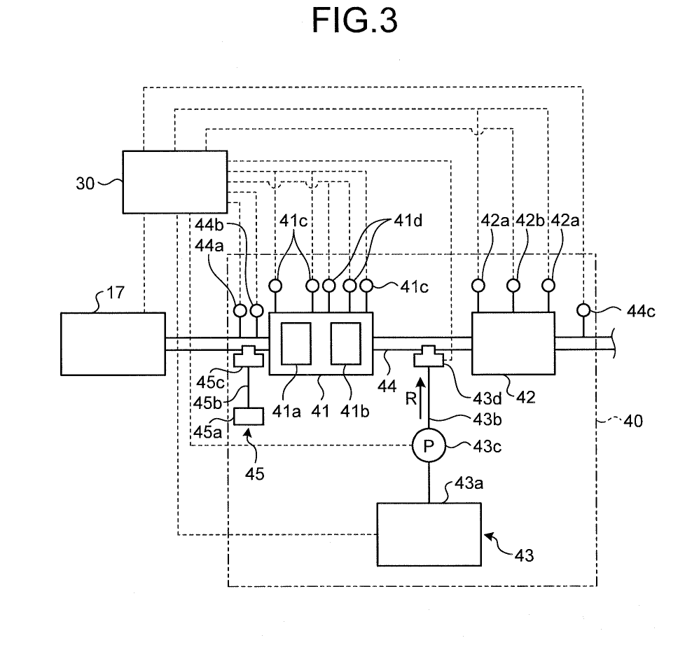

FIG. 3 is a diagram illustrating an example of the internal combustion engine 17 and the exhaust gas treating device 40. As illustrated in FIG. 3, the exhaust gas treating device 40 is a device that purifies exhaust gas discharged from the internal combustion engine 17 to an exhaust pipe 44. The exhaust gas treating device 40 reduces the amount of nitrogen oxide (NOx) or the like included in the exhaust gas. The exhaust gas treating device 40 includes a particulate collecting filter 41, a reduction catalyst 42, a reducing agent supplying unit 43, and a fuel dozer 45. The particulate collecting filter 41 removes particulates such as soot in the exhaust gas of the internal combustion engine 17. The reduction catalyst 42 reduces NOx in the exhaust gas. The reducing agent supplying unit 43 supplies a reducing agent R to the exhaust pipe 44. The fuel dozer 45 supplies fuel to the exhaust pipe 44.

The particulate collecting filter 41 includes a diesel oxidation catalyst 41a, a particulate substance removing filter 41b, a temperature sensor 41c, and a differential pressure sensor 41d. The diesel oxidation catalyst 41a and the particulate substance removing filter 41b are provided inside the exhaust pipe 44. The diesel oxidation catalyst 41a is arranged on the upstream side of the exhaust pipe 44, and the particulate substance removing filter 41b is arranged on the downstream side thereof. The diesel oxidation catalyst 41a is implemented by, for example, platinum (Pt). In addition, the diesel oxidation catalyst 41a oxidizes and removes carbon monoxide (CO) and hydrocarbon (HC) contained in the exhaust gas, and soluble organic fraction (SOF) contained in the particulate substance.

<Control of Engine 36>

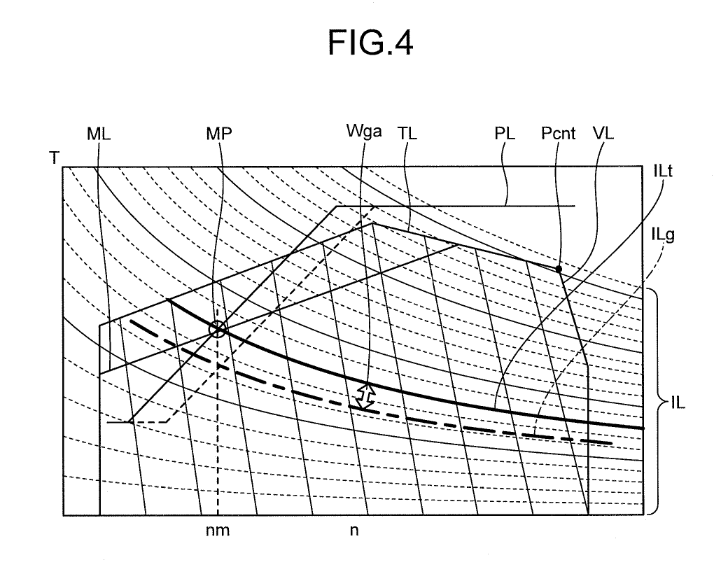

FIG. 4 is a diagram illustrating an example of a torque diagram used for the control of the engine 36 according to the embodiment. The torque diagram is used for the control of the engine 36 and more specifically, the internal combustion engine 17. The torque diagram indicates the relationship between a torque T (N×m) of the output shaft 17S of the internal combustion engine 17 and a rotational speed n (rpm: rev/min) of the output shaft 17S. In the embodiment, the rotor 19R of the generator motor 19 is coupled to the output shaft 17S of the internal combustion engine 17. Therefore, the rotational speed n of the output shaft 17S of the internal combustion engine 17 is in the same rotation as the rotational speed of the rotor 19R of the generator motor 19. Hereinafter, the rotational speed n is referred to as the rotational speed of the output shaft 17S of the internal combustion engine 17 and/or the rotational speed of the rotor 19R of the generator motor 19. In the embodiment, an output of the internal combustion engine 17 and an output of the generator motor 19 when operating as an electric motor are horsepower, and the unit thereof is watt (W). An output of the generator motor 19 when operating as a power generator is electric power, and the unit thereof is watt (W).

The torque diagram includes a maximum torque line TL, a limit line VL, a pump absorption torque line PL, a matching route ML, and an output instruction line IL. The maximum torque line TL indicates a maximum output that the internal combustion engine 17 can generate when the excavator 1 illustrated in FIG. 1 is in operation. The maximum torque line TL indicates the relationship between the rotational speed n of the internal combustion engine 17 and the torque T that can be generated by the internal combustion engine 17 at each rotational speed n.

The torque diagram is used for the control of the internal combustion engine 17. In the embodiment, the engine controller 30 stores the torque diagram in a storage unit, and uses the torque diagram for the control of the internal combustion engine 17. The hybrid controller 23 and/or the pump controller 33 may also store the torque diagram in respective storage units.

The torque T of the internal combustion engine 17 indicated by the maximum torque line TL is determined in consideration of, for example, the durability and an exhaust smoke limit of the internal combustion engine 17. Therefore, the internal combustion engine 17 can generate a torque larger than the torque T corresponding to the maximum torque line TL. Actually, an engine control device such as the engine controller 30 controls the internal combustion engine 17 so that the torque T of the internal combustion engine 17 does not exceed the maximum torque line TL.

The output generated by the internal combustion engine 17, that is, the horsepower, becomes the maximum at an intersection point Pcnt of the limit line VL and the maximum torque line TL. The intersection point Pcnt is referred to as a rated point. An output of the internal combustion engine 17 at the rated point Pcnt is referred to as a rated output. The maximum torque line TL is determined, as described above, based on the exhaust smoke limit. The limit line VL is determined based on a maximum rotational speed. Therefore, the rated output is the maximum output of the internal combustion engine 17 determined based on the exhaust smoke limit and the maximum rotational speed of the internal combustion engine 17.

The limit line VL limits the rotational speed n of the internal combustion engine 17. Specifically, the rotational speed n of the internal combustion engine 17 is controlled by the engine control device such as the engine controller 30 so as not to exceed the limit line VL. The limit line VL defines the maximum rotational speed of the internal combustion engine 17. In other words, the engine control device such as the engine controller 30 controls the maximum rotational speed of the internal combustion engine 17 so as not to exceed the rotational speed defined by the limit line VL and be in an excessive rotation.

The pump absorption torque line PL indicates a maximum torque (pump absorption torque command value) that the hydraulic pump 18 illustrated in FIG. 2 can absorb with respect to the rotational speed n of the internal combustion engine 17. In the embodiment, the internal combustion engine 17 balances, on the matching route ML, the output of the internal combustion engine 17 with the load of the hydraulic pump 18. The matching route ML may be set so as to pass through a point where a fuel consumption rate is sufficient.

The output instruction line IL indicates targets of the rotational speed n and the torque T of the internal combustion engine 17. Specifically, the internal combustion engine 17 is controlled so as to have the rotational speed n and the torque T acquired by the output instruction line IL. As described above, the output instruction line IL corresponds to a second relationship that indicates the relationship between the torque T and the rotational speed n of the internal combustion engine 17 used for defining the magnitude of the motive power generated by the internal combustion engine 17. The output instruction line IL becomes a command value of the horsepower, that is, a command value of the output (hereinafter, appropriately referred to as an output command value) generated by the internal combustion engine 17. In other words, the engine control device such as the engine controller 30 controls the torque T and the rotational speed n of the internal combustion engine 17 so as to be the same as the torque T and the rotational speed n on the output instruction line IL corresponding to the output command value. For example, in a case where an output instruction line ILt corresponds to the output command value, the torque T and the rotational speed n of the internal combustion engine 17 are controlled so as to be the same as values on the output instruction line ILt.

The torque diagram includes a plurality of the output instruction lines IL. A value between the adjacent output instruction lines IL is determined by, for example, interpolation. In the embodiment, the output instruction line IL is an equal horsepower line. The equal horsepower line is a line that determines the relationship between the torque T and the rotational speed n so that the output of the internal combustion engine 17 becomes constant. In the embodiment, the output instruction line IL is not limited to the equal horsepower line, but any line with an equal throttle line may be set.

In the embodiment, the internal combustion engine 17 is controlled so as to have the torque T and a rotational speed nm of a matching point MP. The matching point MP is an intersection point of the matching route ML indicated by a solid line in FIG. 4, the output instruction line ILt indicated by a solid line in FIG. 4, and the pump absorption torque line PL indicated by a solid line. The matching point MP is a point where the output of the internal combustion engine 17 and the load of the hydraulic pump 18 balance. The output instruction line ILt indicated by the solid line corresponds to the target of the output of the internal combustion engine 17 absorbed by the hydraulic pump 18 at the matching point MP, and to the target output for the internal combustion engine 17.

When the generator motor 19 generates electric power, the pump absorption torque line PL is arranged at a position obtained by adding the horsepower absorbed by the generator motor 19, that is, a power generation output Wga, and the output of the internal combustion engine 17 absorbed by the hydraulic pump 18. The pump absorption torque line PL corresponding to the output of the internal combustion engine 17 absorbed by the hydraulic pump 18 is arranged at a position indicated by a dotted line. A line that corresponds to the output of the pump absorption torque line PL indicated by the dotted line is an output instruction line ILg. The pump absorption torque line PL intersects with the output instruction line ILg at a matching point MPa in the rotational speed nm. A line to which the output instruction line ILg and the power generation output Wga absorbed by the generator motor 19 are added is an output instruction line ILt. The output instruction line ILt passes through the matching point MPa.

In the embodiment, there is indicated an example in which the output of the internal combustion engine 17 and the load of the hydraulic pump 18 are balanced at the matching point MPa which is an intersection point of the matching route MLa, the output instruction line ILt, and the pump absorption torque line PL. However, the present invention is not limited to such example; the output of the internal combustion engine 17 and the load of the hydraulic pump 18 may be balanced at a matching point MPb which is an intersection point of the matching route MLb and the output instruction line ILt.

As described above, the engine 36, i.e., the internal combustion engine 17 and the generator motor 19, is controlled based on the maximum torque line TL, the limit line VL, the pump absorption torque line PL, the matching route ML, and the output instruction line IL included in the torque diagram.

<Exemplary Configuration of Hybrid Controller 23>

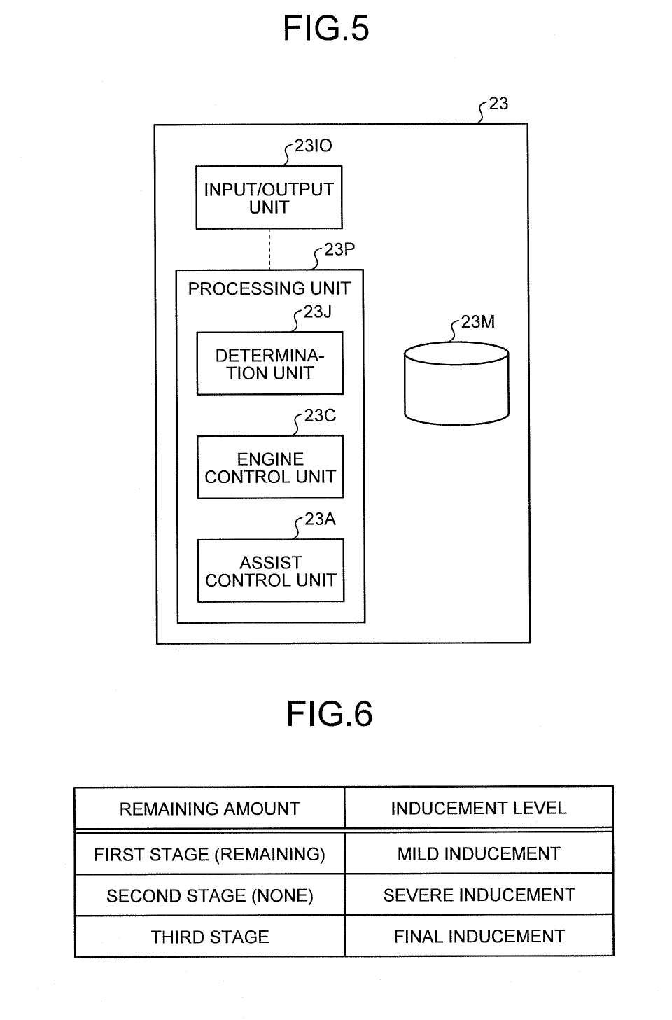

FIG. 5 is a diagram illustrating an exemplary configuration of the hybrid controller 23. The hybrid controller 23 includes a processing unit 23P, a storage unit 23M, and an input/output unit 23IO. The processing unit 23P is a central processing unit (CPU), a microprocessor, a microcomputer, or the like.

The processing unit 23P includes a determination unit 23J, an engine control unit 23C, and an assist control unit 23A. The processing unit 23P and more specifically, the determination unit 23J, the engine control unit 23C, and the assist control unit 23A execute the control method for the hybrid work machine according to the embodiment. The determination unit 23J determines whether the operation mode of the excavator 1 is an output limited mode.

The engine control unit 23C controls the operation of the internal combustion engine 17 and the generator motor 19. When the internal combustion engine 17 shifts from the fuel saving mode to a working mode, for example, the engine control unit 23C increases a rotational speed and/or a torque in order to obtain a required output for work. In addition, for example, at the time of having no load, the engine control unit 23C can increase the rotational speed of the internal combustion engine 17 while maintaining the non-working state. Hereinafter, in the embodiment, in a case of performing work, the control to increase the rotational speed of the internal combustion engine 17 in order to obtain the required output for such work is referred to as rotational speed increasing control. Furthermore, in the embodiment, in a case of performing work, the control to increase the torque of the internal combustion engine 17 in order to obtain the required output for such work is referred to as torque increasing control. In the rotational speed increasing control and the torque increasing control, the output of the internal combustion engine 17 and the load of the hydraulic pump 18 may be balanced at the matching route ML in the torque diagram; however, the present invention is not limited to this. For example, the output of the internal combustion engine 17 and the load of the hydraulic pump 18 may be balanced at a position away from the matching route ML.

For example, when the internal combustion engine 17 and the peripheral equipment of the internal combustion engine 17 (the exhaust gas treating device 40, the injection device 45, and the cooling device 46) are abnormal, and when a purifying ability of the exhaust gas treating device 40 has been reduced, the engine control unit 23C puts the internal combustion engine 17 into the output limited mode. The output limited mode is, for example, a mode of limiting the output of the internal combustion engine 17 by limiting the torque generated by the internal combustion engine 17 to a value smaller than the torque determined by the maximum torque line TL in the torque diagram. In the output limited mode, the engine control unit 23C controls the internal combustion engine 17 using a torque limit line TLa in the torque diagram illustrated in FIG. 12 described later, for example.

In the exhaust gas treating device 40, for example, when the abnormality of the exhaust gas temperature at an inlet of the particulate collecting filter 41 or the abnormality of the deposition state of the particulate substance, such as soot, in the particulate substance removing filter 41b is detected, the engine control unit 23C puts the internal combustion engine 17 into the output limited mode.

The reduction in the purifying ability of the exhaust gas treating device 40 occurs, for example, when the remaining amount of the reducing agent R stored in a reducing agent tank 43a has been reduced. FIG. 6 is a table illustrating the relationship between the remaining amount of the reducing agent R and the output limited mode of the internal combustion engine 17.

As illustrated in FIG. 6, for example, when the remaining amount of the reducing agent R in the reducing agent tank 43a drops below a predetermined ratio (for example, a few percent of a predetermined reference amount), the engine control unit 23C puts the internal combustion engine 17 into a first-stage output limited mode (mild inducement mode). In the mild inducement mode, for example, the engine control unit 23C limits a value of the maximum torque line TL of the internal combustion engine 17 to about 70% of the normal time.

On the other hand, when the remaining amount of the reducing agent R in the reducing agent tank 43a becomes 0%, the engine control unit 23C puts the internal combustion engine 17 into a second-stage output limited mode (severe inducement mode). In the severe inducement mode, for example, the engine control unit 23C reduces a value of the maximum torque line TL of the internal combustion engine 17 to about a half of the normal time, and limits the rotational speed of the internal combustion engine 17.

Moreover, when a predetermined time passes after the remaining amount of the reducing agent R in the reducing agent tank 43a has become 0%, the internal combustion engine 17 is put into a third-stage output limited mode (final inducement mode). In the final inducement mode, the engine control unit 23C further limits the rotational speed of the internal combustion engine 17, in the severe inducement mode, to a value same as at the time of idling.

Other than the remaining amount of the reducing agent R, the engine control unit 23C may put the internal combustion engine 17 into the output limited mode when the abnormality occurs in the quality of the reducing agent R, when the abnormality occurs in an injection unit 43d that injects the reducing agent R, when the abnormality occurs in a circulation system, if provided, that circulates part of the exhaust gas in intake gas, and when the abnormality occurs in a system of the reduction catalyst 42. Furthermore, the output of the internal combustion engine 17 may be controlled in a stepwise manner in accordance with a period of time that has passed from the occurrence of such abnormalities.

In the injection device 45, for example, when the abnormality in an injection operation and the abnormality at a control circuit are detected, the engine control unit 23C puts the internal combustion engine 17 into the output limited mode. In the cooling device 46, for example, when the temperature of the cooling water is detected to be higher than a predetermined threshold value, the engine control unit 23C puts the internal combustion engine 17 into the output limited mode. By limiting the output of the internal combustion engine 17 as described above, the reduction in the exhaust gas purifying ability can be suppressed, and the function of the internal combustion engine 17 and the peripheral equipment can be maintained.

When the abnormalities occur in the internal combustion engine 17 and the peripheral equipment, and when the purifying ability of the exhaust gas treating device 40 is reduced, as described above, the determination unit 23J detects such abnormalities and reduction in the purifying ability, respectively. When any one of the above is detected, the determination unit 23J determines that the internal combustion engine 17 is in the output limited mode.

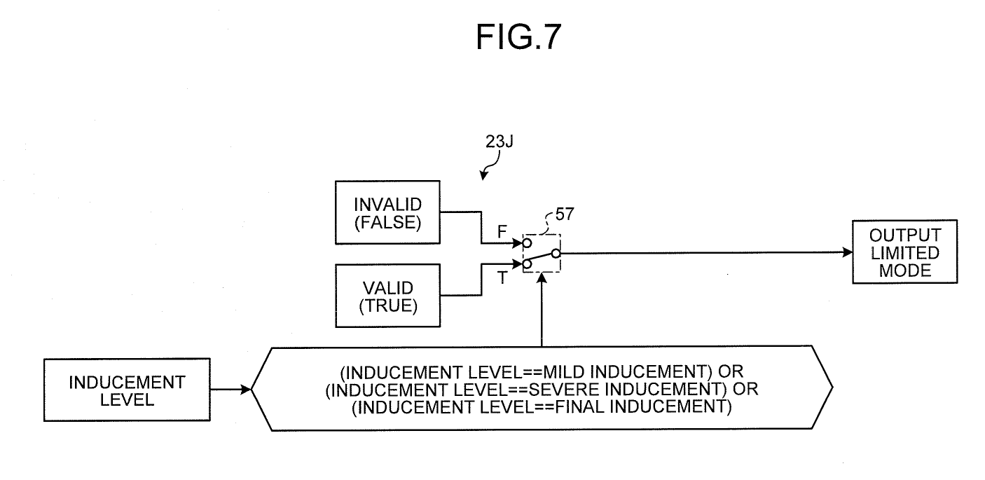

FIG. 7 is a diagram illustrating an example of a control block of the determination unit 23J. The determination unit 23J includes a selection unit 57. A valid flag and an invalid flag of the output limited mode are input to the selection unit 57. The selection unit 57 outputs the valid flag of the output limited mode when an inducement level of the internal combustion engine 17 is the mild inducement, the severe inducement, or the final inducement described above. On the other hand, the selection unit 57 outputs the invalid flag of the output limited mode when the inducement level is not set in the internal combustion engine 17.

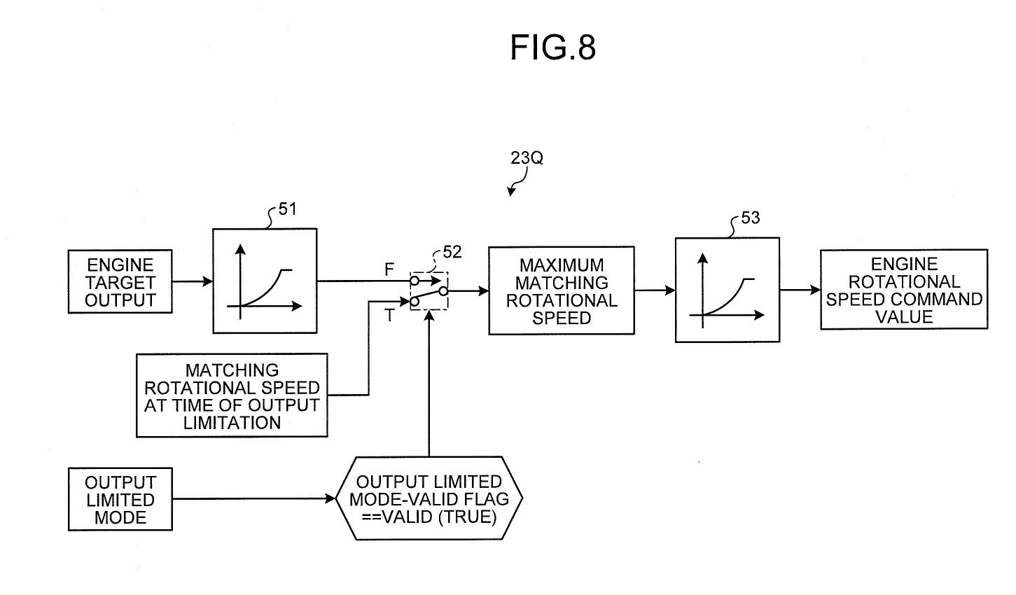

FIG. 8 is a diagram illustrating an example of a control block 23Q of the engine control unit 23C included in the hybrid controller 23. The control block 23Q calculates and outputs a command value of the rotational speed of the internal combustion engine 17. The control block 23Q includes a first conversion table 51, a selection unit 52, and a second conversion table 53. A target output value of the internal combustion engine 17 is input to the first conversion table 51. The target output value is based on a work request for the working unit 3 determined by the operation amount of the operation levers 26R, 26L or the pressure of the hydraulic pump 18. The target output value is converted into a matching rotational speed and output by the first conversion table 51 based on the known data table or the like.

The output value of the first conversion table 51 and a predetermined matching rotational speed value in the output limited mode described above are input to the selection unit 52. A value set by a throttle, for example, may be used for the predetermined matching rotational speed. When the output limited mode-valid flag is invalid (FALSE), the selection unit 52 outputs the output value of the first conversion table 51. In addition, when the output limited mode-valid flag is invalid, the selection unit 52 can reduce the matching rotational speed based on the work request for the working unit 3. On the other hand, when the output limited mode-valid flag is valid (TRUE), the selection unit 52 outputs the predetermined matching rotational speed value. In addition, when the output limited mode-valid flag is valid, the selection unit 52 can invalidate the logic of reducing the matching rotational speed when the work request for the working unit 3 is not required.

The output value of the selection unit 52, that is, the matching rotational speed corresponding to the target output of the internal combustion engine 17 or the predetermined matching rotational speed, is input to the second conversion table 53. The input matching rotational speed is converted into a no-load rotational speed and output by the second conversion table 53 based on the known data table or the like. The output value of the second conversion table 53 becomes a command value of the no-load rotational speed of the internal combustion engine 17.

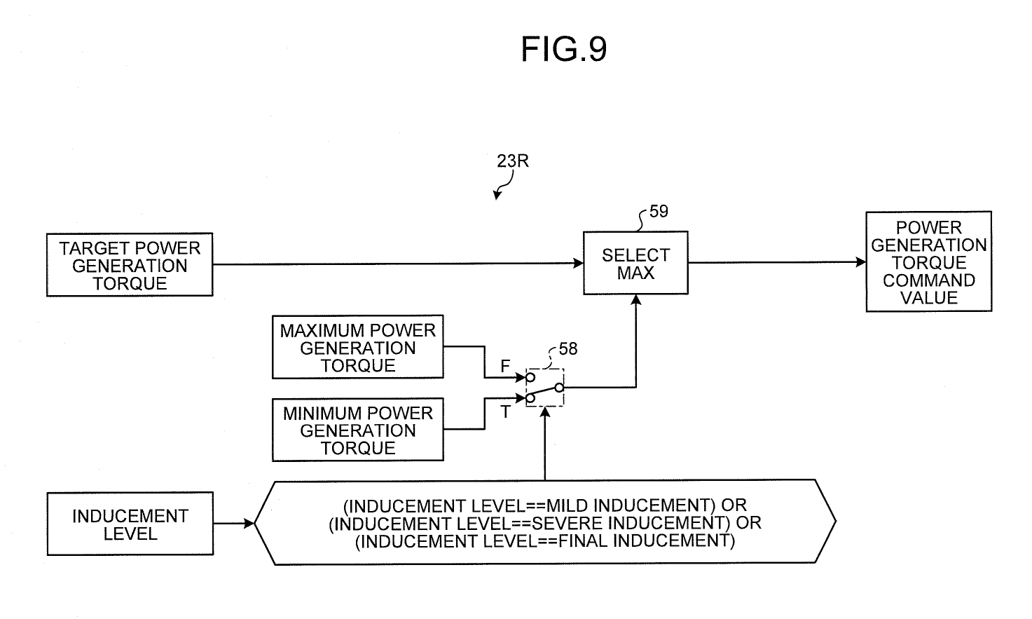

FIG. 9 is a diagram illustrating an example of a control block 23R of the engine control unit 23C included in the hybrid controller 23. The control block 23R calculates and outputs a command value of a power generation torque of the generator motor 19. The control block 23R includes a selection unit 58 and a maximum value selection unit 59. A value of a maximum power generation torque and a value of a minimum power generation torque are input to the selection unit 58. The maximum power generation torque has a maximum absolute value in the range of the power generation torque set in the generator motor 19. The minimum power generation torque has a minimum absolute value in the range of the power generation torque set in the generator motor 19. The maximum power generation torque and the minimum power generation torque have negative values. In order to suppress the reduction in the power generating efficiency, the generator motor 19 is controlled so that electric power is generated in a situation where the power generation torque is equal to or larger than the minimum power generation torque and equal to or smaller than the maximum power generation torque. The selection unit 58 outputs the minimum power generation torque when the inducement level of the internal combustion engine 17 is the mild inducement, the severe inducement, or the final inducement described above. On the other hand, the selection unit 58 outputs the maximum power generation torque when the inducement level is not set in the internal combustion engine 17.

A target power generation torque in the generator motor 19 and the output value of the selection unit 58 are input to the maximum value selection unit 59. The target power generation torque has a negative value. Therefore, the maximum value selection unit 59 outputs a value smallest among the input absolute values as a power generation torque command value. As a result, the minimum power generation torque is output when the inducement level of the internal combustion engine 17 is the mild inducement, the severe inducement, or the final inducement described above. On the other hand, the target power generation torque is output when the inducement level is not set in the internal combustion engine 17.

The hybrid controller 23 can cause the power storage device 22 and the generator motor 19 to perform assist operation in a case of increasing, at the time of working, the output of the internal combustion engine 17 based on the work request, that is, a case of performing, at the time of working, the rotational speed increasing control or the torque increasing control by the engine control unit 23C, for example. The assist operation is control of supplying the electric power stored in the power storage device 22 to the generator motor 19, and driving the generator motor 19 by such electric power. In a case of performing the assist operation, the rotational speed or the torque of the internal combustion engine 17 can be increased in a shorter time; however, the generator motor 19 consumes the electric power. Therefore, the electric power that will be stored in the power storage device 22 reduces.

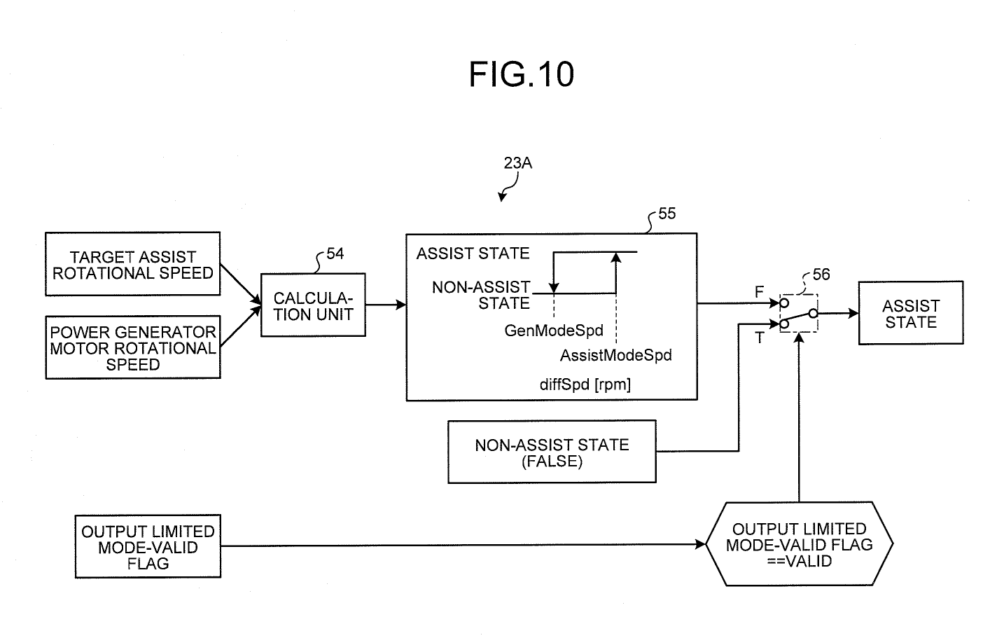

In a case where the operation mode of the excavator 1 is the output limited mode, the assist control unit 23A limits the assist operation when the rotational speed increasing control, at the time of working, is performed. FIG. 10 is a diagram illustrating an example of a control block of the assist control unit 23A. The assist control unit 23A includes a first calculation unit 54, a second calculation unit 55, and a selection unit 56.

The actual rotational speed of the generator motor 19 and a preset target value of a rotational speed (target assist rotational speed) are input to the first calculation unit 54. The first calculation unit 54 calculates and outputs a difference between the target assist rotational speed and the actual rotational speed of the generator motor 19. The output value of the first calculation unit 54 is input to the second calculation unit 55. The second calculation unit 55 outputs the output value of the first calculation unit 54, that is, a signal that indicates an assist state when the difference between the target assist rotational speed and the actual rotational speed of the generator motor 19 is larger than a predetermined value. On the other hand, the second calculation unit 55 outputs a signal that indicates a non-assist state when the difference between the target assist rotational speed and the actual rotational speed of the generator motor 19 is equal to or less than the predetermined value.

The output value of the second calculation unit 55 and the signal that indicates the non-assist state are input to the selection unit 56. When the output limited mode-valid flag described above is valid, the selection unit 56 outputs the signal that indicates the non-assist state. On the other hand, when the output limited mode-valid flag is invalid, the selection unit 56 outputs the output value of the second calculation unit 55.

When the signal that indicates the assist state is output from the assist control unit 23A, the engine control unit 23C causes the assist operation to be performed. On the other hand, when the signal that indicates the non-assist state is output from the assist control unit 23A in the engine control unit 23C, the hybrid controller 23 limits the assist operation. Consequently, the assist operation is performed until the rotational speed of the generator motor 19 reaches the target assist rotational speed.

As an example of limiting the assist operation, the assist control unit 23A can cause the assist operation itself to not be performed. In such case, the electric power stored in the power storage device 22 is not consumed; therefore, the electric power is secured in the power storage device 22. As another example of limiting the assist operation, the assist control unit 23A can reduce the electric power supplied to the generator motor 19 during the assist operation in comparison with the case of not being in the output limited mode. In addition, the assist control unit 23A can make the electric power supplied to the generator motor 19 during the assist operation a constant value. As described above, the power storage device 22 can supply the electric power to the generator motor 19 even at the time of limiting the assist operation. In a case of supplying the electric power in the power storage device 22 to the generator motor 19 at the time of limiting the assist operation, the assist control unit 23A can set the amount of the supplied electric power in accordance with the electric power stored in the power storage device 22 while preventing insufficiency of the voltage in the power storage device 22.

In a case where the processing unit 23P is dedicated hardware, for example, one or the combination of various circuits, a programmed processor, or an application specific integrated circuit (ASIC) corresponds to the processing unit 23P.

For example, various nonvolatile or volatile memories such as a random access memory (RAM) or a read only memory (ROM), and/or various disks such as a magnetic disk is used as the storage unit 23M. The storage unit 23M stores a computer program and information. The computer program is for causing the processing unit 23P to execute the control of the hybrid work machine according to the embodiment. The information is used when the control according to the embodiment is executed by the processing unit 23P. The processing unit 23P implements the control according to the embodiment by reading, from the storage unit 23M, and executing the computer program described above.

The input/output unit 23IO is an interface circuit for connecting the engine controller 30 to the equipment. The units and various sensors, i.e., the fuel adjustment dial 28, the rotational speed detection sensor 17n, the common rail control unit 32, the exhaust gas treating device 40, the injection device 45, and the cooling device 46 illustrated in FIG. 2, and the like are connected to the input/output unit 23IO. In addition, various sensors such as the temperature sensor 41c, the differential pressure sensor 41d, a temperature sensor 42a, an ammonia sensor 42b, a NOx detection sensor 44a, and a pressure sensor 44b illustrated in FIG. 3 are connected to the input/output unit 23IO. In the embodiment, the exemplary configuration of the engine controller 30 has been described, but the hybrid controller 23 and the pump controller 33 have the same configuration as the engine controller 30.

<Control Method for Hybrid Work Machine>

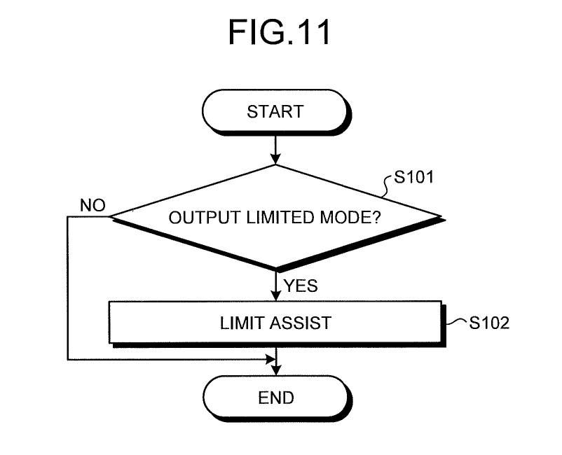

FIG. 11 is a flowchart illustrating an example of the control method for the hybrid work machine according to the present embodiment. In step S101, the determination unit 23J of the engine controller 30 determines whether the operation mode is the output limited mode. When the operation mode is the output limited mode (Yes in step S101), in step S102, the assist control unit 23A limits the assist operation by the generator motor 19 and the power storage device 22. Then, the engine control unit 23C controls the operation of the internal combustion engine 17 and the generator motor 19 in accordance with the limiting contents of the assist operation limited by the assist control unit 23A. On the other hand, when the operation mode is not the output limited mode (No in step S101), the assist control unit 23A does not limit the assist operation. In other words, when the engine control unit 23C performs the rotational speed increasing control at the time of working, the assist control unit 23A causes the power storage device 22 and the generator motor 19 to perform the assist operation.

FIG. 12 is a diagram illustrating a comparative example of the torque diagram in the output limited mode. As illustrated in FIG. 12, in the output limited mode, the maximum torque line TLa that represents the maximum output that can be generated by the internal combustion engine 17 is set to a position downward, that is, a position to which the line is moved in the direction where the torque becomes small, with respect to the maximum torque line TL at normal time. Accordingly, the output and the torque that can be generated by the internal combustion engine 17 are limited to smaller values than normal time.

In the output limited mode described above, in a case where work or the like of the excavator 1 is not performed, the engine control unit 23C can cause the internal combustion engine 17 to operate by, for example, the horsepower corresponding to the output instruction line ILa and a rotational speed nc in the idling state. In such case, the engine control unit 23C, for example, sets the matching point MPc of the internal combustion engine 17 to a position, on the output instruction line ILa, where the rotational speed is nc.

In cases of performing, from such state, the swing operation of the upper swing body 5 and work such as excavating operation of the soil or the like, the engine control unit 23C sets a matching point in accordance with the load of the hydraulic pump 18 or the like. The engine control unit 23C, for example, sets the matching point MPd at the intersection point of the maximum torque line TLa and the pump absorption torque line PLa. A rotational speed nd of the internal combustion engine 17 becomes larger in value than the rotational speed nc in the idling state.

The engine control unit 23C performs the rotational speed increasing control by controlling the rotational speed and the torque of the internal combustion engine 17 so as to shift from the matching point MPc to the matching point MPd. When there is no limitation of the assist operation, the assist control unit 23A causes the assist operation to be performed at the time of performing the rotational speed increasing control. When the assist operation is performed, the electric power of the power storage device 22 is consumed and thus, the insufficiency of the electric power in the power storage device 22 occurs. Moreover, before the internal combustion engine 17 shifts to the matching point MPd, that is, when operating in the matching point MPc, the rotational speed nc of the internal combustion engine 17 is a value at the time of idling. Therefore, the securing of the power generation output becomes difficult.

Accordingly, the assist control unit 23A limits the assist operation performed by the power storage device 22. For example, the assist control unit 23A can cause the assist operation to not be performed, or reduce the electric power supplied to the generator motor 19 during the assist operation in comparison with the case of not being in the output limited mode.

As described above, at the time of an output limitation, the excavator 1 according to the present embodiment can limit the assist operation of supplying the electric power stored in the power storage device 22 to the generator motor 19 in the case of increasing the output of the internal combustion engine 17 based on the work request for the working unit 3 at the time of working. Therefore, the electric power consumption in the power storage device 22 is suppressed. Accordingly, the reduction of the storage capacity of the power storage device 22 at the time of the output limitation can be suppressed. Consequently, the power generation output insufficiency of the power storage device 22 can be suppressed.

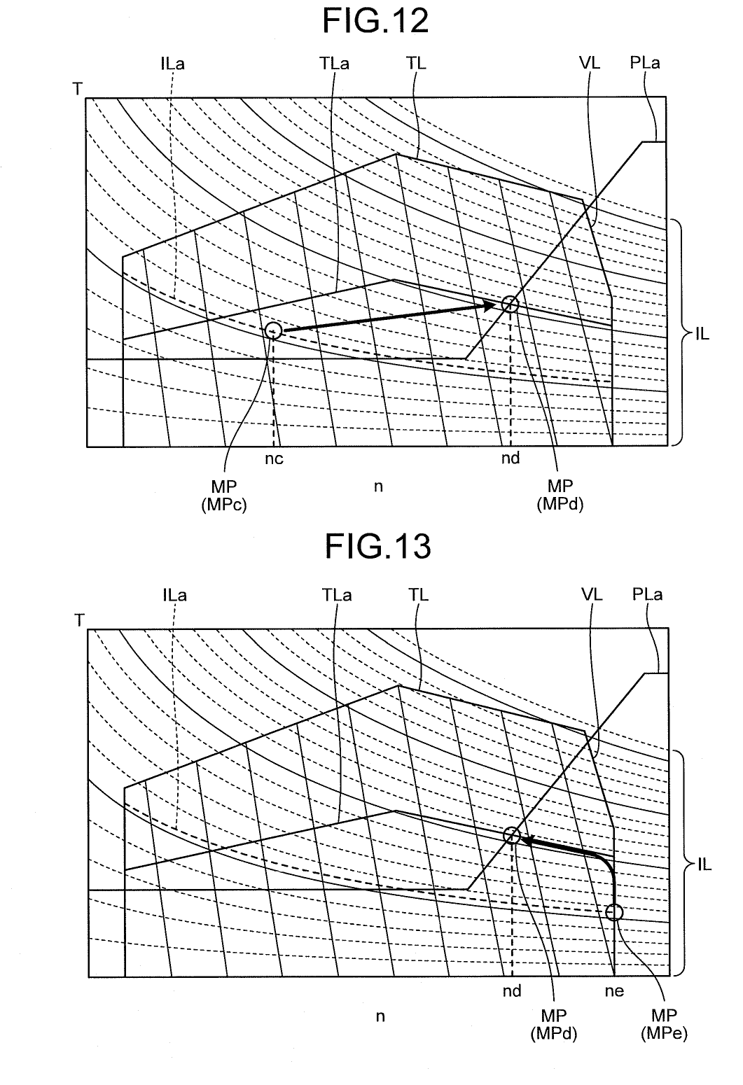

FIG. 13 is a diagram illustrating an example of the torque diagram in the output limited mode. FIG. 13 illustrates the example of a case in which the control of increasing the rotational speed of the internal combustion engine 17 based on the work request for the working unit 3 at the time of working is not performed. As illustrated in FIG. 13, in the output limited mode, the engine control unit 23C may set the matching point MPe of the internal combustion engine 17 at the time of having no load at, for example, an intersection point of the output instruction line ILa and the limit line VL (rotational speed ne). With the configuration described above, accordingly, the rotational speed at the time of having no load is set to the side of high-rotation; therefore, the output for charging the power storage device 22 is secured. For example, when the matching point MPd is set, at the time of working, at a position same as the comparative example illustrated in FIG. 12, the engine control unit 23C can shift the matching point from MPe to MPd without increasing the rotational speed of the internal combustion engine 17. As described above, at the time of the output limitation, the excavator 1 sets the rotational speed at the time of having no load to the side of high-rotation so that the control of increasing the rotational speed of the internal combustion engine 17 based on the work request for the working unit 3 at the time of working is not performed. Accordingly, even in a case where the output of the internal combustion engine 17 is limited and the power generation output of the generator motor 19 is limited, the output for charging the power storage device 22 can be secured. Consequently, the power generation output insufficiency of the power storage device 22 can be suppressed. The matching point (rotational speed) set at the time of having no load may be any value as long as the output for charging the power storage device 22 is secured; therefore, the present invention is not limited to the matching point MPe (rotational speed ne) described above. The control described above that does not allow the control of increasing the rotational speed of the internal combustion engine 17 based on the work request for the working unit 3 at the time of working can be performed independently of the control, in the embodiment described above, that limits the assist operation. In summary, at the time of the output limitation, the excavator 1 may perform the control of setting the rotational speed at the time of having no load to the side of high-rotation so that the control of increasing the rotational speed of the internal combustion engine 17 based on the work request for the working unit 3 at the time of working is not performed, in addition to or instead of the control of limiting the assist operation.

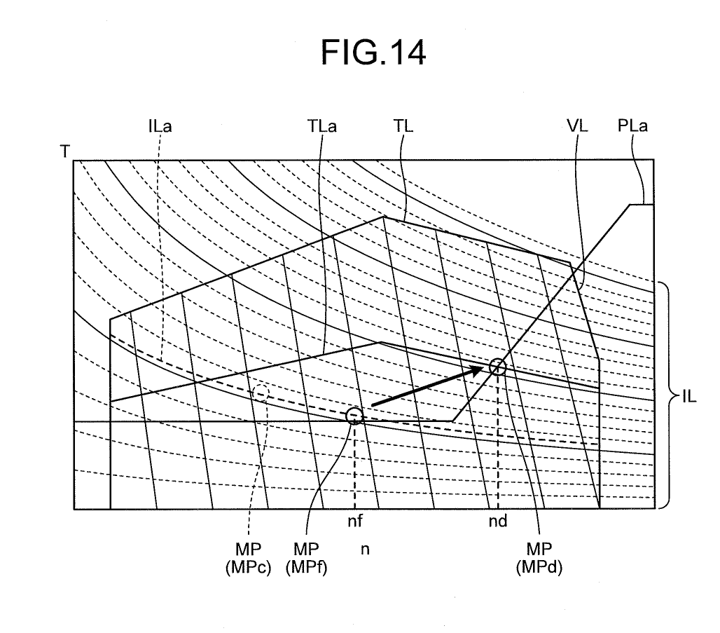

FIG. 14 is a diagram illustrating another example of the torque diagram in the output limited mode. FIG. 14 illustrates the example of a case in which the assist operation is performed so that the electric power supplied to the generator motor 19 is reduced in comparison with the case of not being in the output limited mode. As illustrated in FIG. 14, in the output limited mode, the engine control unit 23C may set the matching point MPf of the internal combustion engine 17 at the time of having no load at, for example, a position where a rotational speed of becomes higher in speed than the matching point MPc on the output instruction line ILa. Accordingly, for example, when the matching point MPd is set, at the time of working, at a position same as the comparative example in FIG. 12, the increasing amount of the rotational speed of the internal combustion engine 17 becomes smaller than the case in which the matching point MPc is set. Therefore, the supplied electric power required for the assist operation can be reduced. Consequently, the consumption of the electric power in the power storage device 22 is suppressed.

In the embodiment, the excavator 1 provided with the internal combustion engine 17 has been used as an example of a work machine; however, the work machine to which the embodiment can be applied is not limited to this. For example, the work machine may be a bulldozer. In addition, the type of an engine mounted on the work machine is not limited.

While the embodiment has been described, the embodiment is not limited to the contents described above. The components described above may include components readily conceivable by those skilled in the art, components substantially identical, and components in a so-called equivalent range. In addition, the components described above can be suitably combined. Furthermore, various kinds of omission, replacement, and modification may be made in the components in the scope not departing from the gist of the embodiment.

### REFERENCE SIGNS LIST

1 Excavator
5 Upper swing body
17 Internal combustion engine
18 Hydraulic pump
19 Generator motor
22 Power storage device
23 Hybrid controller
26L, 26R Operation lever
30 Engine controller
23A Assist control unit
23C Engine control unit
23M Storage unit
23P Processing unit
23IO Input/output unit
23J Determination unit
33 Pump controller
36 Engine
40 Exhaust gas treating device
41 Particulate collecting filter
42 Reduction catalyst
45 Injection device
46 Cooling device

1. A control device that controls a hybrid work machine, wherein the hybrid work machine includes:
a working unit;
an internal combustion engine that supplies motive power to the working unit;
a generator motor connected to an output shaft of the internal combustion engine; and
a power storage device that stores electric power generated by the generator motor, or supplies electric power to the generator motor,
the control device comprising:
a determination unit that determines whether a situation is at a time of an output limitation in which an output of the internal combustion engine is limited;
an assist control unit that limits, at the time of the output limitation, an assist operation of supplying the electric power stored in the power storage device to the generator motor in a case of increasing an output of the internal combustion engine based on a work request for the working unit at a time of working; and
an engine control unit that controls the internal combustion engine and the generator motor in a state in which the assist operation is limited by the assist control unit.

2. The control device that controls the hybrid work machine according to claim 1, wherein
the assist control unit stops the assist operation at the time of the output limitation.

3. The control device that controls the hybrid work machine according to claim 1, wherein
the determination unit determines that a situation is at the time of the output limitation in a case where the internal combustion engine and peripheral equipment of the internal combustion engine are in abnormal states, and/or in a case where a purifying ability of an exhaust gas treating device, when the exhaust gas treating device is provided in the internal combustion engine, is reduced or possibly reduced.

4. The control device that controls the hybrid work machine according to claim 3, wherein
the peripheral equipment includes:
the exhaust gas treating device that treats exhaust gas of the internal combustion engine;
an injection device that injects fuel into the internal combustion engine; and
a cooling device that cools the internal combustion engine.

5. The control device that controls the hybrid work machine according to claim 1, wherein
at the time of the output limitation, the engine control unit changes to a matching rotational speed in an output limited mode through a control of increasing a rotational speed of the internal combustion engine based on the work request for the working unit at the time of working.

6. A hybrid work machine comprising:
an internal combustion engine that includes an exhaust gas treating device;
a generator motor coupled to an output shaft of the internal combustion engine;
a power storage device that stores electric power generated by the generator motor, or supplies electric power to the generator motor; and
the control device that controls the hybrid work machine according to claim 1, the control device controlling the internal combustion engine, the generator motor, and the power storage device.

7. The hybrid work machine according to claim 6, further comprising:
a vehicle body that includes a traveling body, and a swing body provided on the traveling body and swingable relative to the traveling body; and
a motor provided such that electric power is supplied from the generator motor and/or the power storage device, the motor driving the swing body.

8. A control method for a hybrid work machine that includes an internal combustion engine that drives a working unit, and a generator motor connected to the internal combustion engine and transfers and receives electric power to/from a power storage device, the control method comprising:
determining whether a situation is at a time of an output limitation in which an output of the internal combustion engine is limited;
at the time of the output limitation, limiting an assist operation of supplying the electric power stored in the power storage device to the generator motor in a case of increasing an output of the internal combustion engine based on a work request for the working unit at a time of working; and
controlling the internal combustion engine and the generator motor in a state in which the assist operation is limited.
